(19) United States
(12) Patent Application Publication
(10) Pub. No.: US 2008/0301801 A1
(43) Pub. Date: Dec. 4, 2008

(54) Policy based virtual private network (VPN) communications

(76) Inventor: Premkumar Jothimani, Tamil Nadu (IN)

Correspondence Address: SCHWEGMAN, LUNDBERG & WOESSNER/NOVELL, PO BOX 2938, MINNEAPOLIS, MN, 55402, US

(21) Appl. No.: 11/904,376

(22) Filed: Sep. 27, 2007

(30) Foreign Application Priority Data
May 31, 2007 (IN) 1167/DEL/2007

(51) Int. Cl. G06F 15/16

(52) U.S. Cl. 726/15

(57) ABSTRACT

Techniques for policy based virtual private network (VPN) communications are provided. A principal uses a client device to establish a VPN session with a remote processing environment. At the remote processing environment, policies are evaluated and are used for modifying permissible VPN routes that the client uses on behalf of the principal during the VPN session. The modified VPN routes are dynamically pushed to the client at the start of the VPN session and dynamically enforced by the client with communications, which are initiated by the principal during the VPN session.

### RELATED APPLICATIONS

The present application claims priority to India Patent Application No. 1167/DEL/2007 filed in the India Patent Office on May 31, 2007 and entitled “POLICY BASED VIRTUAL PRIVATE NETWORK (VPN) COMMUNICATIONS;” the disclosure of which is incorporated by reference herein.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the example pseudo source code as described below and in any drawings hereto: Copyright © 2007, Novell, Inc., Provo, Utah—All Rights Reserved.

### FIELD

The invention relates generally to security and more particularly to techniques for achieving policy based virtual private network (VPN) communications.

### BACKGROUND

Increasing the affairs of individuals and enterprises are being conducted in an automated manner over the Internet. Enterprises now engage in selling their products and services over the Internet; individuals also engage in communicating with one another over the Internet; employees may also engage in accessing secure resources of their employers over the Internet, etc.

One ever present and daunting issue with this activity is Internet security. Some transactions may be innocuous and may not require any substantial security. However, a growing number of transactions do involve sensitive material associated with enterprises and individuals, such as corporate secrets, personal data, etc. A variety of security mechanisms exist to address this issue.

For example, some enterprises may install dedicated connections for secure communications between parties. Yet, this approach is less pervasive with the advent of Virtual Private Network (VPN) techniques. A VPN permits an insecure connection to be used to achieve secure communications between parties engaged in a transaction.

VPN transactions use authentication and encryption techniques for purposes of ensuring that communications are secure. Essentially, a VPN permits insecure communications lines to be used in a secure manner.

However, even during VPN communications an enterprise may want to restrict access to some of its assets from a particular user. In these situations, an enterprise enforces restrictions against certain transactions made by the user to the enterprise environment. This ensures the level of security desired by the enterprise during the VPN communications but can also heavily load the enterprise environment with many transactions that should never have been made and processed in the first instance. That is, the enterprise environment must handle the unauthorized transactions made during the VPN communications even if only to deny those transactions. This unnecessarily wastes network bandwidth and processing capacity within the enterprise environment.

Consequently, there is a need for improved policy based VPN communications.

### SUMMARY

In various embodiments, techniques for policy based virtual private network (VPN) communications are provided. In an embodiment, a VPN session with a client of a principal is initiated. One or more policies are accessed; the policies identify selective resources that the principal can permissibly accesses during the VPN session. Next, VPN routes are constructed for use by the client during the VPN session in response to the identified selective resources. Finally, the VPN routes are pushed to the client for the principal to use during the VPN session to access the identified selective resources.

### BRIEF DESCRIPTION OF THE DRAWINGS

FIG. 1 is a diagram of a method for a policy based Virtual Private Network (VPN) communications, according to an example embodiment.

FIG. 2 is a diagram of another method for policy based VPN communications, according to an example embodiment.

FIG. 3 is a diagram of a policy based VPN communication system, according to an example embodiment.

FIG. 4 is a diagram another policy based VPN communication system, according to an example embodiment.

### DETAILED DESCRIPTION

A “resource” includes a user, content, a processing device, a node, a service, an application, a system, a directory, a data store, groups of users, combinations of these things, etc. The term “service” and “application” may be used interchangeably herein and refer to a type of software resource that includes instructions, which when executed by a machine performs operations that change the state of the machine and that may produce output. Additionally, a “principal” is a type of resource that actively interacts with other resources. So, a principal may be a user or an automated service.

A “client” is an environment having one or more machines that is enabled over a network and that includes resources and in some cases processes the resources. A “server” is also an environment having one or more machines that is enabled over a network and that includes resources and in some cases processes the resources. The terms “client” and “server” when used in combination define a client-server architecture, where the client and server are remote from one another over a network connection, such as a wide-area network (WAN) and insecure public communications network such as the Internet. Both a client and a server may be viewed as types of resources similar to what was described above with reference to the principal.

The term “remote” is used relatively herein. In other words, when the term “remote” is used as an adjective to a noun it is remote or external to some other entity being referenced within the context of the modified noun. So, as an example: a remote application to a service means that the remote application is external to a local environment and local network associated with the service. In other contexts, the service may be viewed as being remote to the application when it is expressed as: a remote service to an application. Within any given context herein, the term remote is used consistently to identify what entity is in fact remote to what other entity.

A “processing environment” refers to one or more physical processing devices organized within a network. For example, several computers connected via a local area network (LAN) may collectively be viewed as a processing environment. The processing environment also refers to software configurations of the physical processing devices, such as but not limited to operating system, file system, directory service, etc.

According to an embodiment, an authentication service is a service or application that is trusted and communicates securely with resources, such as principals, clients, servers, etc. The authentication service provides single sign-on authentication for principals, as described more completely herein and below. In an embodiment, the authentication is an identity service, which refers to a special type of service that is designed to manage and supply authentication services and authentication information for resources. So, an identity service may authenticate a given resource for access to a variety of local and external services being managed by that identity service. A single resource may have multiple identity services. In addition the identity service itself may be viewed as a type of resource. In this manner, identity service may authenticate and establish trust with one another viewing one another as specific type of resource.

Some example identity services are described in “Techniques for Dynamically Establishing and Managing Authentication and Trust Relationships,” filed on Jan. 27, 2004, and having the U.S. Ser. No. 10/765,523; “Techniques for Establishing and Managing a Distributed Credential Store,” filed on Jan. 29, 2004, and having the U.S. Ser. No. 10/767,884; and “Techniques for Establishing and Managing Trust Relationships,” filed on Feb. 3, 2004, and having the U.S. Ser. No. 10/770,677; all of which are commonly assigned to Novell, Inc., of Provo, Utah and the disclosures of which are incorporated by reference herein.

A resource is recognized via an “identity.” An identity is authenticated via various techniques (e.g., challenge and response interaction, cookies, assertions, etc.) that use various identifying information (e.g., identifiers with passwords, biometric data, hardware specific data, digital certificates, digital signatures, etc.). A “true identity” is one that is unique to a resource across any context that the resource may engage in over a network (e.g., Internet, Intranet, etc.). However, each resource may have and manage a variety of identities, where each of these identities may only be unique within a given context (given service interaction, given processing environment, etc.).

The identity may also be a special type of identity that the resource assumes for a given context. For example, the identity may be a “crafted identity” or a “semantic identity.” An example for creating and using crafted identities may be found in U.S. patent application Ser. No. 11/225,993; entitled “Crafted Identities;” filed on Sep. 14, 2005; and the disclosure of which is incorporated by reference herein. An example for creating and using semantic identities may be found in U.S. patent application Ser. No. 11/261,970; entitled “Semantic Identities;” filed on Oct. 28, 2005; and the disclosure of which is incorporated by reference herein.

Various embodiments of this invention can be implemented in existing network architectures, storage systems, security systems, data centers, and/or communication devices. For example, in some embodiments, the techniques presented herein are implemented in whole or in part in the Novell® network, proxy server products, email products, operating system products, data center products, and/or directory services products distributed by Novell®, Inc., of Provo, Utah.

Of course, the embodiments of the invention can be implemented in a variety of architectural platforms, operating and server systems, devices, systems, or applications. Any particular architectural layout or implementation presented herein is provided for purposes of illustration and comprehension only and is not intended to limit aspects of the invention.

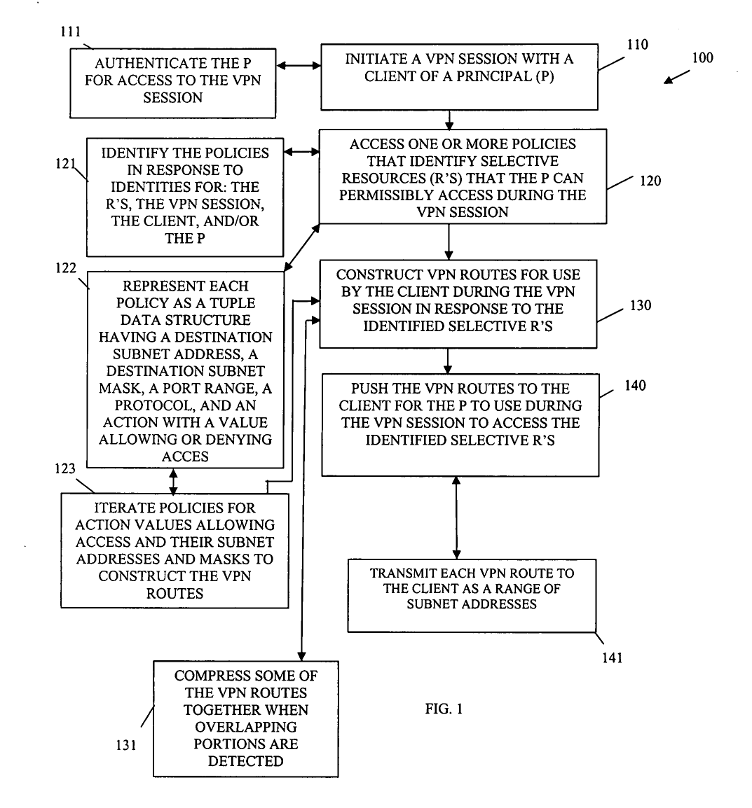

It is within this context, that various embodiments of the invention are now presented with reference to the FIGS. 1-4.

FIG. 1 is a diagram of a method 100 for a policy based Virtual Private Network (VPN) communications, according to an example embodiment. The method 100 (hereinafter “VPN policy service”) is implemented as instructions in a machine-accessible and readable medium. The instructions when executed by a machine perform the processing depicted in FIG. 1. The VPN policy service is also operational over and processes within a network. The network may be wired, wireless, or a combination of wired and wireless.

At 110, the VPN policy service initiates a VPN session with a client of a principal. According to an embodiment, at 111, the VPN policy service may be used to authenticate the principal for access to the VPN session. In other embodiments, the VPN policy service may enlist third-party services, such as an identity service described and incorporated by reference above, to assist in authenticating the principal for access to the VPN session.

At 120, the VPN policy service accesses one or more policies that identify selective resources, which the principal can permissibly access during the VPN session. In other words, policies are placed on resources, which are available within a server-side environment of the VPN session and these policies are available and accessible to the VPN policy service when the principal initially establishes the VPN session.

The policies themselves can include a variety of information and be located in a variety of locations. For example, at 121, the VPN policy service may identify the policies in response to identities that are associated with the resources, the VPN session, the client of the principal, and/or the principal. So, the granularity of the policies can be configured based on requirements of an enterprise. Again, the identities may be managed and acquired via an identity service, such as the identity services discussed and incorporated by reference above.

Additionally, at 122, each policy may be represented as a tuple data structure. In an example tuple data structure the following information is included: a destination subnet address, a destination subnet mask, a communication port range, a permissible protocol, and an action. The action has a value that includes either “allow” or “deny.” An indication of allowance means that for that particular policy, which is associated with a particular resource, the principal is permitted to access the particular resource during the VPN session. Conversely, an indication of denial means that the principal is not permitted to access a particular resource during the VPN session.

Continuing with the example embodiment presented, at 123, the VPN policy service may iterate a list of available policies for actions values indicating “allow.” For each such policy, the VPN policy service also acquires the subnet address and subnet mask and uses this to construct the VPN routes.

Accordingly, at 130, the VPN policy service constructs VPN routes for use by the client during the VPN session in response to the identified selective resources acquired via policy enforcement. The VPN routes are dynamically customized and supplied in response to the policy evaluation. Routes to resources are just provided when the principal engaged in the VPN session has permissible access to those resources. Thus, when the client of the principal, discussed below, receives the routes there will not be any VPN transactions during the VPN session for which the principal is not allowed to proceed with. This means that the server-side environment of the VPN session having the resources just processes transactions that have already been evaluated and permitted by policy.

Traditionally, all routes that could access resources were sent to the client and then subsequent to that access restrictions were enforced on the server leading to unnecessary bandwidth usage and processing throughput bottlenecks. Here, the VPN policy service evaluates policy on the server side of the VPN session before the client side of the VPN session receives VPN routes; in this manner, when the VPN session commences at the client side only authorized transactions that were policy evaluated are sent from the client so bandwidth is reduced from traditional approaches and server-side processing throughput increased.

In an embodiment, at 131, the VPN policy service can also improve performance at the client side by compressing some of the VPN routes together when overlapping portions are detected. Some example pseudo code for achieving this is discussed in greater detail below. Essentially, the VPN policy service looks at each of the VPN routes and determines if some overlap with one another or can be combined and if so they are combined. This reduces the number of routes sent to and that have to be processed by the client during the VPN session.

At 140, the VPN policy service pushes the VPN routes to the client for the principal to use during the VPN session to access the identified selective resources. Again, some of these VPN routes may have been compressed as discussed above at 131. In an embodiment, at 141, each VPN route may be transmitted as a range of subnet addresses. So, a single route may be expressed as a range of subnet addresses.

Some example scenarios and pseudo code is now presented for further illustration on the processing associated with the VPN policy service. It is to be understood that these example scenarios are presented for purposes of ease of comprehension only and are not intended to limit the embodiments of the invention to any particular implementation.

### Example Illustrations

When a VPN client connects to the VPN policy service (VPN server), communication routes pointing to the private network of the VPN are pushed to the client. These routes redirect the traffic intended to the private network to the VPN server.

Traditionally, the practice is to push routes that point to the entire private subnet. However, resources accessed by the VPN client are governed by policies configured by the administrator. Thus, during the VPN session the policies are enforced at the VPN server side of the processing and many of the VPN transactions may be invalidated at the server side of the processing creating bottlenecks in bandwidth and processing throughput.

Each policy is represented as a tuple with the following fields: “{Destination Subnet Address, Destination Subnet Mask, Port range, Protocol, Action}.”

The “Action” field takes a value of either “ALLOW” or “DENY.” Thus even if the route pushed to the client points to the entire private subnet, not all the traffic redirected will be allowed into the private subnet. The exact routing information may be generated from the administrator configured policies. Thus, the load on the VPN server is reduced by pushing only the generated routes instead of the route pointing to the entire private subnet. In short, minimal policy checking is enforced at the VPN client by using a routing table and pushing routes based on configured policies.

Example: Consider the following scenario where 10.5.16.145/255.255.252.0 is the private subnet. A VPN server has been configured to access the following resource using a VPN client policy: “10.5.16.145/255.255.252.0,0,Any,Allow.”

The above given policy allows a VPN client to access only machines in the 10.5.16.145/24 subnet. Hence, even though the route pushed to the client would correspond to the subnet “10.5.16.145/255.255.252.0”, only the resources with IP in the “10.5.16.*” subnet will be allowed to access. Hence, only the route pointing to “10.5.16.145.0/24” is pushed to the client, so that the load on the VPN server is greatly reduced since most of the unwanted traffic is blocked at the client itself.

Thus, the VPN client traffic is shaped by carefully modifying the routing information pushed to the client, based on the administrator configured policies.

The illustration shows a simple example, however in the deployment scenario, policies can be more complex. In order to push the minimum number of routes without sacrificing the routing effect, the following algorithm is discussed.

### Routing Information Extraction

As mentioned in the previous section, routes pushed to the client are generated based on the policies configured by the administrator. An example algorithm used involves following steps:

The result containing list of routes (denoted by subnets) will be pushed to the client.

| i. | For each policy with action = “allow” | |
|---|---|---|
| | 1. | If list is empty, insert the subnet specified in the policy and |
| | | move to next policy |
| | 2. | If list is not empty, compare the subnet specified in the policy |
| | | with subnets already present in the list. The logic involved |
| | | is given below. |

| | |
|---|---|
| 1. | For each subnet in the list |

| | |
|---|---|
| 1. | If the subnet in the list overlaps with the subnet in the |
| | policy then remove the subnet from the list and |
| | construct a new subnet in the following manner. |
| | Lets assume that SN_P refers to the subnet in |
| | the current policy under examination and |
| | SN_L refers to the subnet in the list under |
| | examination. SN_N refers to the new subnet. |
| | Starting address of SN_N = min |
| | (starting address of SN_P, starting |
| | address of SN_L) |
| | Ending address of SN_N = max |
| | (ending address of SN_P, ending |
| | address of SN_L) |
| | Re-start from the beginning of the list by |
| | comparing against the new subnet SN_N. |
| 2. | If the subnets are mutually exclusive, add the subnet |
| | in the policy to the list in a sorted order and proceed |
| | to the next policy. |
| 3. | If the subnets are same or if the subnet in the policy is |
| | a subset of the subnet in the list then ignore the |
| | current policy and move to the next policy. |
| | © Novell, Inc. 2007 |

The list obtained will contain set of subnets whose routes have to be pushed to the client.

In general access to protected network resources are governed by list of policies configured by the administrator. When data traffic reaches the VPN policy service from VPN clients, policy is enforced on the data and a decision is made whether to allow the traffic or discard. For the data traffic to reach the VPN gateway, routes pointing to the protected network will be pushed to the VPN client during session initialization. Typical policies configured will be a tuple containing Destination subnet (denoted by an address/mask pair), range of ports in that particular subnet and the associated action (to allow or deny that particular traffic).

In the above mentioned tuple, the destination subnet will be the key for generating routes that are to be pushed to the client. In order to compress the route list, each configured subnet is considered as range of numbers whose starting address and the ending address are known from the address/mask pair used to denote the subnet. Two subnets are combined into one if they comprise of overlapping range of addresses. The following is some example logic for comparing and combining two subnets.

Let p_address and p_mask denote subnet p. Similarly q_address and q_mask denote subnet q.

Starting address of subnet p is p_address and Ending address of subnet p is p_address+˜p_mask where ‘˜’ bitwise NOT operation. Similar values can be found for q. Using above derived values, compare the range of numbers for the following cases.

Both are same subnets, hence only one can be retained

Both are exclusive subnets, hence both of them should be retained

Subnets overlap. In this case the resulting range of address will be
pq_start=min (p_start_address, q_start_address)
pq_end=max (p_end_address, q_end_address)
where ‘pq’ represent the combined subnet. To denote the above obtained values as a subnet the address/mask pair will be

pq_start/(˜(pq_end-pq_start)).
© Novell, Inc. 2007

The routes extracted from the list of policies (referred as routes list) is maintained in a sorted list to reduce the number of comparisons required for compressing and combining the route list without loosing the routing effect. Following steps summarizes the algorithm used for extracting the routes from the policy list.
1. For each policy in policy list whose action is “allow ” go to step 2
2. If the resulting route list is empty, add the subnet of the current policy and go to step 1.
3. For each route in the route list, compare the current policy's subnet and combine if possible using the previously described algorithm for combining subnets. Go to step 1.
   © Novell, Inc. 2007

Thus an efficient algorithm is employed to extract the minimal list of routes from the list of policies and most of the unwanted data traffic is distilled at the client using the derived route list.

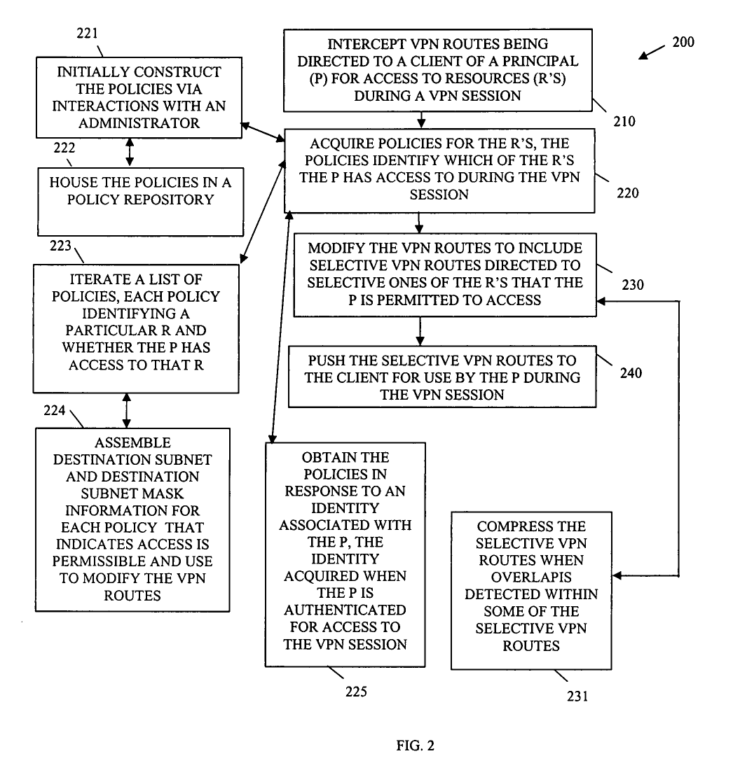

FIG. 2 is a diagram of another method 200 for policy based VPN communications, according to an example embodiment. The method 200 (hereinafter “VPN policy routing service”) is implemented in a machine-accessible and readable medium as instructions. The instructions when executed by a machine perform the processing depicted in the FIG. 2. Moreover, the VPN policy routing service is operational over a network, and the network may be wired, wireless, or a combination of wired and wireless.

The VPN policy routing service presents an alternative perspective and in some cases enhanced perspective to the VPN policy service represented by the method 100 of the FIG. 1 described above.

At 210, the VPN policy routing service intercept VPN routes that are being directed to a client of a principal for access to resources during a VPN session. The VPN policy routing service may be configured as a proxy, such as a reverse proxy that the client is unaware of and even that a VPN server application is unaware of. Although, this does not have to be the case in every instance. The VPN policy routing service detects when VPN routes are being sent or going to be sent to a client for purposes of communicating with the client during a VPN session. Essentially, at VPN session initialization and before the client receives its VPN routes for communication the VPN routes are intercepted, acquired, and modified in the manners discussed herein and below.

At 220, the VPN policy routing service acquires policies for the resources that are available during the VPN session to the principal via the principal's client. Each policy is associated with a particular resource. The VPN policy routing service uses the policies to determine which resources the principal is to have access to during the VPN session.

Prior to 220, at 221, the VPN policy routing service can initially construct the policies via interactions with an administrator. Each policy is associated with a particular resource, a particular grouping of resources, and the principal. Moreover, each policy can include a range of Internet Protocol (IP) addresses for use by the principal for purposes of acquiring access to the particular resource to which that particular policy relates or acquiring access to the particular grouping of resources to which that particular policy relates.

In an embodiment, at 222, the policies may be housed in a policy repository for subsequent retrieval and use by the VPN policy routing service. Each policy may be retrieved from the repository using an identity associated with one or more of the following: a particular resource, a particular grouping of resources, the client, the VPN session, and the principal. In some cases, the identity service (discussed above) may house and distribute the policies to the VPN policy routing service in response to identities supplied by the VPN policy routing service to the identity service.

According to an embodiment, at 223, the VPN policy routing service iterates a list of policies. Each unique policy is associated with a particular resource available or that could be potentially available during the VPN session. Each unique policy also identifies whether the principal is to be given access to that particular resource during the VPN session. The policy was previously configured and established by an administrator. In some cases, at 224, the policy may also include other useful information or may supply a reference to other useful information. For example, each policy may include destination subnet address and mask information and an indication as to whether access to that information is permissible for the principal during the VPN session. Each allowable destination subnet address and mask is assembled for each resource by iterating the policies. This information is then used to modify the VPN routes.

In an embodiment, at 225, the VPN policy routing service obtains the policies in response to an identity associated with the principal. That identity associated with the principal is acquired when the principal is authenticated for access to the VPN session. So, the policies are configured and unique to the identity of the principal and a single policy exists for each resource available or potentially available to the principal during the VPN session.

At 230, the VPN policy routing service modifies the VPN routes to include selective VPN routes directed to selective ones of the resources that the principal is permitted to access during the VPN session. According to an embodiment, at 231, the VPN policy routing service compresses the selective VPN routes when overlap is detected with some of the selective VPN routes. An example algorithm and technique for achieving this was presented and discussed above in detail with reference to the method 100 of the FIG. 1.

At 240, the VPN policy routing service pushes the selective VPN routes to the client for use by the principal during the VPN session. That is, the VPN policy routing service dynamically and in real time pushes the selective VPN routes to the principal's client, such that transactions emanating from the principal during the VPN session appear along those identified VPN routes. In this manner, the policy based access for the VPN session is effectively enforced at the client side of the VPN session. The actual policies enforced during VPN initialization and configuration at the server side of the VPN session; but conformed to and effectively complied with during the VPN session on the client side.

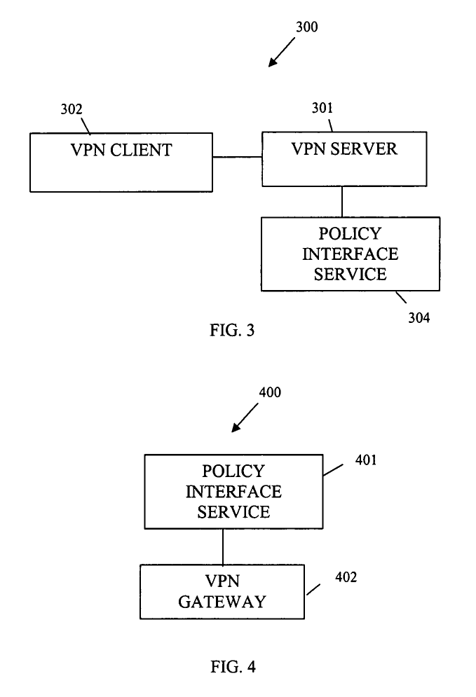

FIG. 3 is a diagram of a policy based VPN communication system 300, according to an example embodiment. The policy based VPN communication system 300 is implemented as instructions on or within a machine-accessible and readable medium. The instructions when executed by one or more machines perform the processing depicted in the methods 100 and 200 of the FIGS. 1 and 2, respectively. The policy based VPN communication system 300 is operational over a network that may be wired, wireless, or a combination of wired and wireless.

The policy based VPN communication system 300 includes a VPN server 301 and a VPN client 302. In some embodiments, the policy based VPN communication system 300 may also include a policy interface service 303. Each of these and there interactions with one another will now be discussed in turn.

The VPN server 301 is implemented in a machine-accessible and readable medium and is to process on a server machine (processing device). Example processing and features of a VPN server 301 was provided in detail above with reference to the VPN policy service represented by the method 100 of the FIG. 1 and with reference to the VPN policy routing service represented by the method 200 of the FIG. 2.

The VPN server 301 is to communicate securely with the VPN client 302 over an insecure network, such as via HTTPS. The VPN server 301 upon initiation of a VPN session with the VPN client 302 evaluates policies for resources that are available during the VPN session to a principal associated with the VPN client 302. The policies are identified and evaluated in response to an identity associated with or attributed to the principal. The principal is authenticated for access to the VPN session and this permits the identity of the principal to be recognized and used by the VPN server 301.

The VPN server 301 evaluates the policies to produce selective VPN routes that the VPN client 302 is to use during the VPN session on behalf of the principal to access resources. The VPN server 301 dynamically and in real time pushes the selective VPN routes from the server processing environment of the VPN session to the client processing environment of the VPN session managed by the VPN client 302. Once the VPN client 302 has the selective VPN routes, the VPN client 302 ensures that only transactions directed to these VPN routes are used by the principal during the VPN session. This ensures that the client side of the VPN session is enforcing already evaluated policy and reduces bandwidth and improves processing throughput for the server side of the VPN session.

In an embodiment, the VPN server 301 compresses a number of the selective VPN routes when overlapping routes are detected within the selective VPN routes. Examples of these were provided above. This compression reduces the size and amount of routes sent from the VPN server 301 to the VPN client 302. This can also improve bandwidth and improve processing efficiency at the VPN client 302.

As was elaborated upon above, each policy identifies or is associated with a particular resource and a particular principal. Each policy can also be customized for a particular principal and particular resource. Moreover, each policy can include a particular range of valid IP addresses for accessing that resource along with a particular protocol and a particular communication or device port for the communications to occur. Each policy also includes a flag or indication as to whether the principal is to be given access to the resource via the range of IP addresses.

It is noted that a particular policy may be used for a grouping of resources. So, the resources may be grouped together and identified with a particular policy.

The VPN client 302 is implemented in a machine-accessible and readable medium and is to process on a client machine (processing device). Some example processing and some features of a VPN client 302 were discussed above with reference to VPN policy service represented by the method 100 of the FIG. 1 and with reference to the VPN policy routing service represented by the method 200 of the FIG. 2.

The VPN client 302 is used to interact with the VPN server 301 on behalf of the principal and establish a VPN session for purposes of accessing one or more resources within the server environment. During initialization, the VPN client 302 may assist or facilitate the principal in authenticated to the VPN session. Additionally, during initialization and before the VPN session commences the VPN client 302 receives the selective VPN routes for the principal to use during the VPN session from the VPN server 301. These selective VPN routes are provided after policy has already been evaluated and enforced by the VPN server 301. So, the VPN client 302 invalidates any traffic emanating from the principal during the VPN session that is directed to other routes not identified or included within the selective VPN routes that the VPN client 302 received from the VPN server 301 during VPN session initialization.

According to an embodiment, the policy based VPN communication system 300 may also include a policy interface service 303. The policy interface service 303 is implemented in a machine-accessible and readable medium and is to process on the server machine or on a different machine within a processing environment of the server machine.

The policy interface service 303 permits the policies to be initially constructed and managed. Thus, the policy interface service 303 presents an interface to an administrator to initially identify and/or define each policy. Again, each policy may be associated with groupings of resources or a particular resource and each policy is associated with a particular principal or roles that groupings of principals may be assigned to during any given VPN session.

FIG. 4 is a diagram another policy based VPN communication system 400, according to an example embodiment. The policy based VPN communication system 400 is implemented as instructions on or within a machine-accessible and readable medium. The instructions when executed by one or more machines perform enhanced processing depicted with respect to the methods 100 and 200 of the FIGS. 1 and 2, respectively. The policy based VPN communication system 400 is also operational over a network, and the network may be wired, wireless, or a combination of wired and wireless.

The policy based VPN communication system 400 presents an alternative view and perspective to the policy based VPN communication system 300 of the FIG. 3.

The policy based VPN communication system 400 includes a policy interface service 401 and a VPN gateway 402. Each of these and their interactions with one another will now be discussed in turn.

The policy interface service 401 is implemented in a machine-accessible and readable medium and is to process on a server machine. Some example processing associated with the policy interface service 401 is presented above with reference to the system 300 of the FIG. 3.

The policy interface service 401 resides within a server environment and permits policy to be managed, constructed, identified, and distributed. The policies define IP addresses or ranges of IP addresses for particular resources or particular groupings of resources as they relate to particular principals. Moreover, the policies provide indications as to whether a particular principal or a particular role for groupings of principals can access the IP addresses or range of IP addresses during any given VPN session.

During separate communication sessions, an administrator defines or identifies the policies via interactions with the policy interface service 401. The policy interface service 401 also permits the VPN gateway 402 to search and retrieve lists or groupings of policies in response to a variety of factors, such as but not limited to, identities of principals, identities of VPN sessions, identities of clients used by principals, identities of resources, identities of roles assumed by principals, identities of groupings of resources, etc.

The VPN gateway 402 is implemented in a machine-accessible and readable medium and is to process on the server machine or on a different machine within a processing environment of the server machine. Some example features associated with the VPN gateway 402 may be found above with reference to the methods 100 and 200 of the FIGS. 1 and 2 and the system 300 of the FIG. 3.

The VPN gateway 402 modifies VPN routes during a VPN session initialization for a principal. These modified VPN routes may also be compressed to eliminate overlaps in a number of the addresses or range of addresses. The VPN routes (which may be compressed as well) are then dynamically and in real time sent to a VPN client of the principal to complete the VPN session initialization. Modification of the VPN routes occurs in response to evaluation of the policies, which are acquired from the policy interface service 401. In some cases, the VPN routes are dynamically and automatically pushed to the VPN client of the principal when the principal initially and successfully authenticates to a VPN session that is being established. The VPN client and the principal are not aware that the VPN routes have been modified and selectively produced in response to policy evaluation and yet since the VPN routes reflect the results of policy evaluation, the VPN client is effectively enforcing policy at the client side of the VPN during the VPN session.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
initiating a virtual private network (VPN) session with a client of a principal;
accessing one or more policies that identify selective resources that the principal permissibly accesses during the VPN session;
constructing VPN routes for use by the client during the VPN session in response to the identified selective resources; and
pushing the VPN routes to the client for the principal to use during the VPN session to access the identified selective resources.

2. The method of claim 1, wherein initiating further includes authenticating the principal for access to the VPN session.

3. The method of claim 1, wherein accessing further includes identifying the one or more policies in response to one or more of the following: resource identities for the identified selective resources, a VPN session identity for the VPN session, a client identity for the client, and a principal identity for the principal.

4. The method of claim 1, wherein accessing further includes representing each policy as a tuple data structure that includes a destination subnet address, a destination subnet mask, a port range, a protocol, and an action, wherein the action includes a value of allow or deny.

5. The method of claim 4, wherein accessing further includes iterating the policies for action values of allow and their destination subnet addresses and corresponding destination subnet masks to construct the VPN routes.

6. The method of claim 1, wherein constructing further includes compressing some of the VPN routes together when overlapping portions of the VPN routes are detected.

7. The method of claim 1, wherein pushing further includes transmitting each VPN route to the client as a range of subnet addresses.

8. A method, comprising:
intercepting VPN routes being directed to a client of a principal for access to resources during a VPN session;
acquiring policies for the resources, wherein the policies identify which of the resources the principal has access to during the VPN session;
modifying the VPN routes to include selective VPN routes directed to selective ones of the resources that the principal is permitted to access; and
pushing the selective VPN routes to the client for use by the principal during the VPN session.

9. The method of claim 8, wherein acquiring further includes iterating a list of policies, wherein each policy of the list is identified with a particular one of the resources, and wherein each policy indicates whether the principal has access to a particular resource to which that policy relates.

10. The method of claim 8, wherein acquiring further includes assembling destination subnet and destination subnet mask information for each policy indicating access is permissible, wherein the destination subnet and destination subnet mask information are used to modify the VPN routes and produce the selective VPN routes.

11. The method of claim 8, wherein acquiring further includes obtaining the policies in response to an identity associated with the principal, which is acquired when the principal is authenticated for access to the VPN session.

12. The method of claim 8 further comprising, initially constructing the policies via interactions with an administrator, wherein each policy is associated with a particular resource, a particular grouping of the resources, and the principal, and wherein each policy includes a range of Internet Protocol (IP) addresses for use by the principal to access the particular resource or the particular grouping of the resources during the VPN session.

13. The method of claim 12 further comprising, housing the policies in a policy repository for subsequent access, each policy retrievable from the policy repository using an identity associated with one or more of the following: the particular resource, the particular grouping of the resources, the client, the VPN session, and the principal.

14. The method of claim 8, wherein modifying further includes compressing the selective VPN routes when overlap is detected within some of the selective VPN routes.

15. A system, comprising:
a Virtual Private Network (VPN) server implemented in a machine accessible medium and to process on a server machine; and
a VPN client implemented in a machine accessible medium and to process on a client machine, and wherein the VPN server is to communicate securely with the VPN client via a VPN session, and wherein the VPN server upon initiation of the VPN session is to evaluate policies for resources in response to an identity associated with an authenticated principal, the evaluation is to produce selective VPN routes that the VPN client is to use during the VPN session on behalf of the principal to access the resources during the VPN session, and wherein the VPN server pushes the selective VPN routes to the VPN client to complete the initiation of the VPN session between the VPN server and the VPN client.

16. The system of claim 15, wherein the VPN client invalidates traffic during the VPN session that is directed from the principal to other routes, wherein the other routes are not included in the selective VPN routes.

17. The system of claim 15, wherein the VPN server is to compress a number of the selective VPN routes when overlapping routes are detected within the selective VPN routes.

18. The system of claim 15, wherein each policy identifies a particular resource, a particular range of valid Internet Protocol addresses, a particular protocol, a particular port for access to the particular resource, and an indication as to whether the principal has access to the particular resource or does not have access to the particular resource.

19. The system of claim 18 further comprising, a policy interface service implemented in a machine-accessible and readable medium and to process on the server machine, wherein the policy interface service is to present an interface to an administrator to initially define each policy.

20. A system, comprising:
a policy interface service implemented in a machine-accessible and readable medium and to process on a server machine; and
a Virtual Private Network (VPN) gateway implemented in a machine-accessible and readable medium and to process on the server machine, wherein the policy interface service is to manage and is to house a policy for each resource of a processing environment as it relates to a principal, and wherein each policy identifies whether the principal is to have access and identifies an address or range of addresses for the principal to use to interact with that particular resource, and wherein the VPN gateway is to modify VPN routes that are sent to a VPN client of the principal during a VPN session to just include the addresses or range of addresses identified by the policies and acquired by the VPN gateway from the policy interface service.

21. The system of claim 20, wherein an administrator during a separate communication session defines the policies via interactions with the policy interface service.

22. The system of claim 20, wherein the VPN gateway is to compress a number of the addresses or the ranges of addresses to eliminate overlaps before they are sent to the VPN client of the principal.

23. The system of claim 22, wherein the VPN gateway is to dynamically push the addresses or the range of addresses when the principal initially authenticates with and successfully establishes the VPN session.
